(19) United States
(12) Patent Application Publication
(10) Pub. No.: US 2020/0120330 A1
(43) Pub. Date: Apr. 16, 2020

(54) SYSTEM & METHOD FOR PROVIDING A SIMULATED ENVIRONMENT

(71) Applicant: Richard N. Berry, San Marcos, CA (US)

(72) Inventor: Richard N. Berry, San Marcos, CA (US)

(21) Appl. No.: 16/297,984

(22) Filed: Mar. 11, 2019

Related U.S. Application Data
(60) Provisional application No. 62/640,169, filed on Mar. 8, 2018.

(51) Int. Cl. H04N 13/351; G06F 3/14; H04N 5/232; H04N 13/302

(52) U.S. Cl. CPC H04N 13/351; H04N 13/302; H04N 5/23238; G06F 3/1423

(57) ABSTRACT

The disclosure concerns a system and method for implementing flat and/or curved display screens, which screens are integrated in such a way as to substantially cover the walls and/or ceiling of a room, and software-manipulated video content adapted for display on the display screens, the combination of which providing a simulated environment, by visual means, or visual and auditory means, whereby the room is adapted to present a simulated environment to one or more persons within the room.

### CROSS-REFERENCE TO RELATED APPLICATIONS

This application claims benefit of priority with U.S. Provisional Application Ser. No. 62/640,169, filed Mar. 8, 2018; the entire contents of which are hereby incorporated by reference.

### BACKGROUND

### Field of the Invention

The invention relates to a system and method for providing a simulated environment.

More particularly, the invention relates to such a system and method implementing flat and/or curved display screens, which screens are integrated in such a way as to substantially cover the walls and/or ceiling of a room, and software-manipulated video content adapted for display on the display screens, the combination of which providing a simulated environment, by visual means, or visual and auditory means, whereby the room is adapted to present a simulated environment to a person within the room.

### Description of the Related Art

360-degree video (“spherical video content”) is typically recorded using either a special rig of multiple cameras, or using a dedicated camera that contains multiple camera lenses embedded into the device, and filming overlapping angles simultaneously. Through a method known as video stitching, this separate footage is merged into one spherical video piece, and the color and contrast of each shot is calibrated to be consistent with the others. This process is done either by the camera itself, or using specialized software such as MISTIKA VR (https://www.sgo.es/mistika-vr/) or KOLOR AVP (http://www.kolor.com/) that can analyze common visuals and audio to synchronize and link the different camera feeds together.

Spherical video content is typically formatted in an equirectangular projection and is either monoscopic, with one image directed to both eyes, or stereoscopic, viewed as two distinct images directed individually to each eye for a 3D effect. Due to this projection and stitching, equirectangular video exhibits a lower quality in the middle of the image than at the top and bottom. Spherical videos are frequently in curvilinear perspective with a fisheye effect. The heavy barrel distortion often requires rectilinear correction before applications in detection, tracking or navigation.

Specialized omnidirectional cameras and rigs have been developed for the purpose of filming spherical video content, including rigs such as GOPRO's OMNI and ODYSSEY (which consist of multiple action cameras installed within a frame), and contained cameras like the HUMANEYES VUZE and NOKIA OZO. There have also been handheld dual-lens cameras such as the RICOH THETA S, SAMSUNG GEAR 360, GARMIN VIRB 360, and the KOGETO DOT 360. Any of these, or similar cameras can be utilized to obtain spherical video content.

While technologies for obtaining spherical video content, and technologies for experiencing virtual reality and perspective-manipulated 3D-video on a flat viewable screen exist in the prior art; there has yet to be provided a system and method for providing a simulated environment to one or more persons within a room utilizing spherical video content. Such system and method would enable one or more persons to, inter alia, remotely experience an environment, such as in a dining or similar setting.

### SUMMARY

A system and method is described for implementing flat and/or curved display screens, which screens are integrated in such a way as to substantially cover the walls and/or ceiling of a room, and software-manipulated video content adapted for display on the display screens, the combination of which providing a simulated environment, by visual means, or with the addition of audio componentry may provide visual and auditory means, whereby the room is adapted to present a simulated environment to one or more persons within the room.

These and other objects, features, and characteristics of the system and/or method disclosed herein, as well as the methods of operation and functions of the related elements of structure and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the invention. As used in the specification and in the claims, the singular form of “a”, “an”, and “the” include plural referents unless the context clearly dictates otherwise.

### BRIEF DESCRIPTION OF THE DRAWINGS

The disclosed embodiments have other advantages and features which will be more readily apparent from the following detailed description of the invention and the appended claims, when taken in conjunction with the accompanying drawings, in which:

FIG. 1 shows a section view of a system for providing a simulated environment to one or more persons within a room;

FIG. 2 shows a room having a rectangular footprint and corresponding periphery;

FIG. 3 shows a room having an elliptic footprint and corresponding periphery;

FIG. 4 shows a room having an integrated array of display panels extending about a periphery of the room;

FIG. 5 shows a room having an integrated array of display panels extending about a periphery of the room, including a ceiling thereof, and further includes an array of curved-display panels at each abutment of two adjoining arrays of flat-display panels;

FIG. 6 illustrates fitted video content formed by adapting spherical video content to a curve-fitting signature;

FIG. 7 illustrates a three-dimensional aspect map including a first map-component, a second map-component, and a curved map-component therebetween;

FIG. 8 is a top plan view of a spherical video camera mount for obtaining spherical video content from a plurality of cameras; and

FIG. 9 is a side plan view of the spherical video camera mount of FIG. 8.

### DETAILED DESCRIPTION

The figures and the following description relate to preferred embodiments by way of illustration only. It should be noted that from the following discussion, alternative embodiments of the structures and methods disclosed herein will be readily recognized as viable alternatives that may be employed without departing from the principles of what is claimed.

Reference will now be made in detail to the preferred embodiments, examples of which are illustrated in the accompanying figures. It is noted that wherever practicable similar or like reference numbers may be used in the figures and may indicate similar or like functionality. The figures depict embodiments of the disclosed system (or method) for purposes of illustration only. One skilled in the art will readily recognize from the following description that alternative embodiments of the structures and methods illustrated herein may be employed without departing from the principles described herein.

### General Description

In general, a system is disclosed for providing a simulated environment to one or more persons within a room, the system comprising: (i) an integrated array of display panels extending about a periphery of the room, the integrated array of display panels forming a three-dimensional surface, wherein the three-dimensional surface correlates with a three-dimensional aspect map; and (ii) fitted video content configured for display on the integrated array of display panels, the fitted video content comprising spherical video content being modified with a curve-fitting signature; wherein the curve-fitting signature is configured to adapt the spherical video content according to the three-dimensional aspect map.

In some embodiments, the integrated array of display panels can be configured to extend from floor to ceiling about the periphery of the room. In other embodiments, the integrated array of display panels can be configured to extend about a ceiling along the periphery of the room.

In some embodiments, the integrated array of display panels may comprise: a first array of flat-display panels adapted to cover a first surface of the room, a second array of flat-display panels adapted to cover a second surface of the room that is distinct from the first surface, and an array of curved-display panels connected to each of the first and second arrays and forming a transition therebetween. In this regard, the three-dimensional aspect map can comprise a first map-component for display on the first array of flat-display panels, a second map-component for display on the second array of fat-display panels, and a curved map-component for display on the array of curved-display panels.

In another aspect, a method for providing a simulated environment to one or more persons within a room is disclosed, wherein the method comprises: (i) obtaining a three-dimensional aspect map corresponding to an integrated array of display panels; (ii) obtaining spherical video content; (iii) modifying the spherical video content with a curve-fitting signature to convert the spherical video content to fitted video content, wherein the curve-fitting signature is configured to adapt the spherical video content according to the three-dimensional aspect map for fitment with the integrated array of display panels; and (iv) displaying the fitted video content on the integrated array of display panels.

### Integrated Array of Display Panels

The integrated array of display panels may comprise one or more flat-display panels, one or more curved-display panels, or a combination thereof, each interconnected to form an integrated array capable of displaying a three-dimensional video content.

The integrated array of display panels generally spans a periphery of a room, for example, an area spanning floor to ceiling about the periphery of the room, or an area of the ceiling spanning the periphery of the room, or both.

The integrated array of display panels forms a three-dimensional surface covering the walls, ceiling, or combination of walls and ceiling of the room. The three-dimensional surface correlates with a three-dimensional aspect map. The three-dimensional aspect map comprises data, generally in the form of a data matrix, for relating in virtual space a representation of the physical three-dimensional surface associated with the integrated array of display panels. In this regard, the pixel arrangement integrated array of display panels is reconstructed in virtual three-dimensional space using a computer and software.

Various conventional display panels can be provided for implementation in accordance with the various embodiments of the invention, particularly as flat-display panels and/or curved-display panels, including but not limited to: electroluminescent displays (ELDs); liquid crystal displays (LCDs), including light-emitting diode (LED)-backlit LCDs; light-emitting diode (LED) displays; organic light-emitting diode (OLED) displays; active-matrix organic light-emitting diode (AMOLED) displays; plasma display panels (PDPs); NEC dvLED displays, quantum dot (QD) displays, and twisted nematic (TN) panels, among others.

Conventional techniques can be utilized form an integrated array of display panels as described herein; i.e. preferably using bezel-less displays, wall-mounts, and HDMI or other cables to complete the array.

Of importance to the instant invention is that the integrated array of display panels is configured about the periphery of a room, either covering floor to ceiling about the periphery of the room, or covering the ceiling about the periphery of the room, or covering the floor about the periphery of the room, or any combination thereof. Such a three-hundred-sixty-degree display enables the simulated environment to be provided to one or more persons within the room.

In any configuration, the integrated array of display panels forms a three-dimensional surface, for viewing from inside the room, wherein the three-dimensional surface correlates with the three-dimensional aspect map. The three-dimensional aspect map is used to modify spherical video content for fitment about the integrated array of display panels.

### Fitted Video Content

Fitted video content is created for display on the integrated array of display panels. The fitted video content generally comprises spherical video content being modified with a curve-fitting signature, wherein the curve-fitting signature is configured to adapt the spherical video content according to the three-dimensional aspect map

First, spherical video content is obtained. Such spherical video content may be obtained by download from a digital library of existing content, or by using a spherical rig of multiple cameras or a dedicated camera that contains multiple camera lenses embedded into the device, and filming overlapping angles simultaneously.

The overlapping video is “stitched” using a known technique, such that the video is seamlessly integrated across the multiple angles.

Next, the three-dimensional aspect map, which provides a virtual representation of the physical viewing surface of the integrated array of display panels, is called up in computer software. A curve-fitting signature is obtained which corresponds to the three-dimensional aspect map. In the software program, the aspect map can be modeled and the curve-fitting signature obtained, generally as a data matrix. The curve-fitting signature is then applied to the spherical video content for converting the spherical video content into a fitted video content, wherein the fitted video content is configured for display according to the three-dimensional aspect map. In this regard, the spherical video is changed to a format which is optimized for display about the integrated array of display panels.

### Illustrated Embodiments

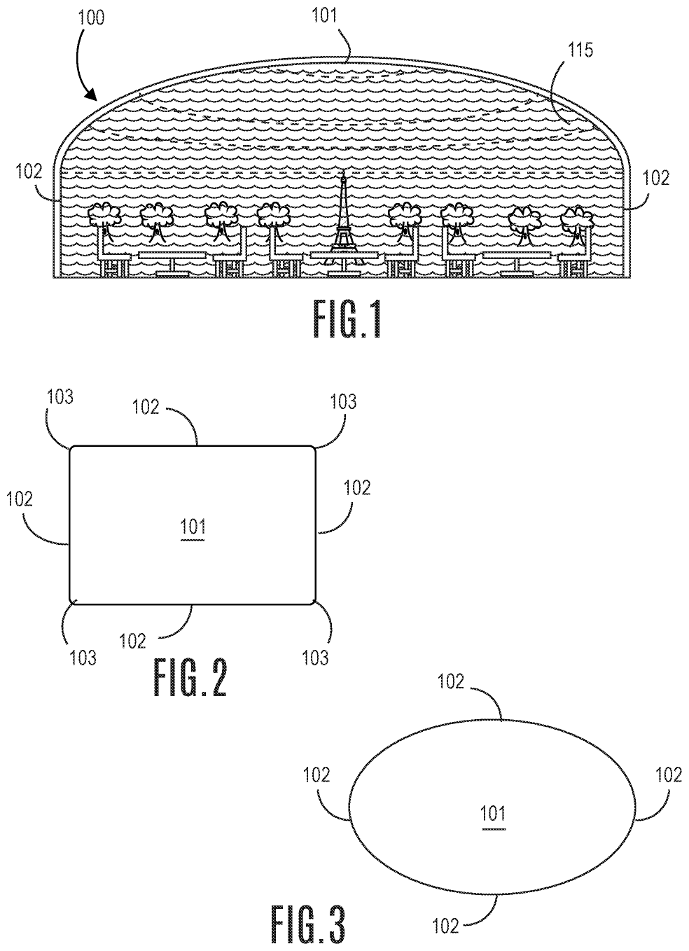

Now, turning to the drawings, FIG. 1 shows a section view of a system 100 for providing a simulated environment to one or more persons within a room. Here, the room comprises walls 102 and ceiling 101 connecting the walls. A plurality of display panels are installed about the walls and ceiling to form an integrated array of display panels 115. The integrated array of display panels is adapted to display a three-dimensional video content about the walls and ceiling within the room, such that a user within the room is provided a simulated environment, such as, for example, the Eiffel tower in Paris, France, or the pyramids of Egypt, etc.

The simulated environment can be particularly useful in a myriad of applications, including, inter alia, a restaurant, a sporting experience, and other entertainment-related applications. In this regard, a person can conduct an activity, such as enjoying a meal, with the simulated experience of being at another location via the projection of fitted video content on the integrated array of display panels.

FIG. 2 shows a room having a rectangular footprint and corresponding periphery. In this regard, the room comprises a plurality of walls 102 arranged in a rectangular shape. Each of the walls meets at a respective abutment 103. The plurality of walls 102 and abutments 103 defining a periphery of the room. A ceiling 101 is provided above the walls and spanning the periphery.

FIG. 3 shows a room having an elliptic footprint and corresponding periphery. Here, a single curved wall 102 continues about all sides of the elliptic periphery of the room. A ceiling 101 is provided above the wall and spanning the periphery. Thus, the room can have any shape, including elliptical or rectangular shapes as-illustrated.

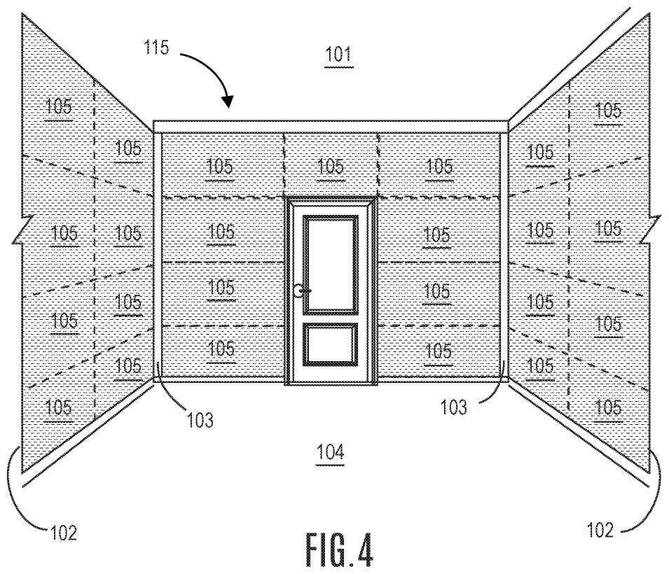

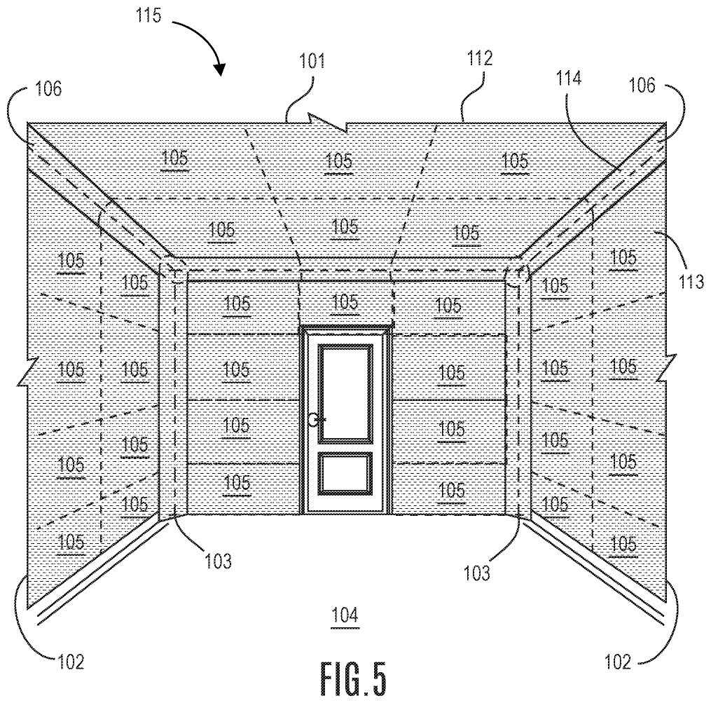

FIG. 4 shows a room having an integrated array of display panels 115 extending about a periphery of the room (only three sides are shown from this perspective). The room comprises a rectangular shape with four walls, three of which are shown, each wall comprises a sub-array of display panels 105. Each sub-array of display panels meets another sub-array of display panels at an abutment 103. The room comprises a ceiling 101 and floor 104, each of which may be optionally covered with an array of display panels. Each of the display panels are connected and combined to form the integrated array of display panels.

FIG. 5 shows a room having an integrated array of display panels 115 extending about a periphery of the room, including a ceiling 101 thereof, and covering walls 102, and further includes an array of curved-display panels 106 at each abutment 103 of two adjoining arrays of flat-display panels 105. The floor 104 is shown not covered by display panels, but may optionally be implemented with a floor array of display panels. Moreover, the integrated array of display panels comprises a first array of flat-display panels 112, a second array of flat-display panels 113, and an array of curved-display panels 114 connecting therebetween. The array of curved-display panels provides a transition between different planar sub-arrays.

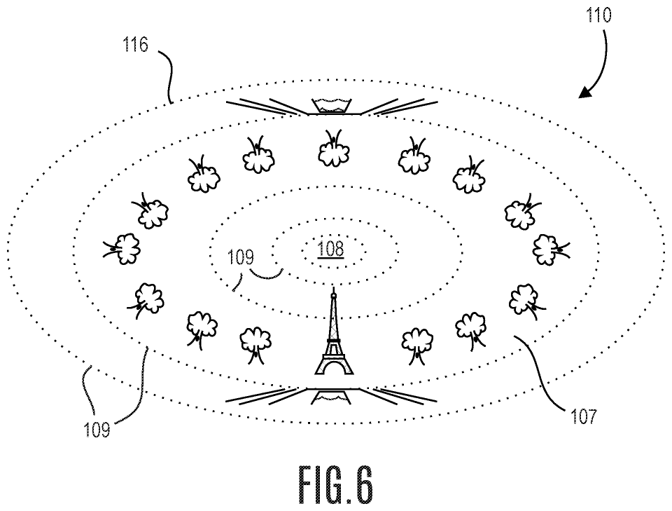

FIG. 6 illustrates fitted video content 110 formed by adapting spherical video content 107 to a curve-fitting signature 109. Here, the curve-fitting signature is applied from the periphery 116 at the floor to an apex 108 for fitment with a dome-shaped three-dimensional aspect map; i.e. in a dome-shaped room with a curved integrated array of display panels within the dome-shaped room.

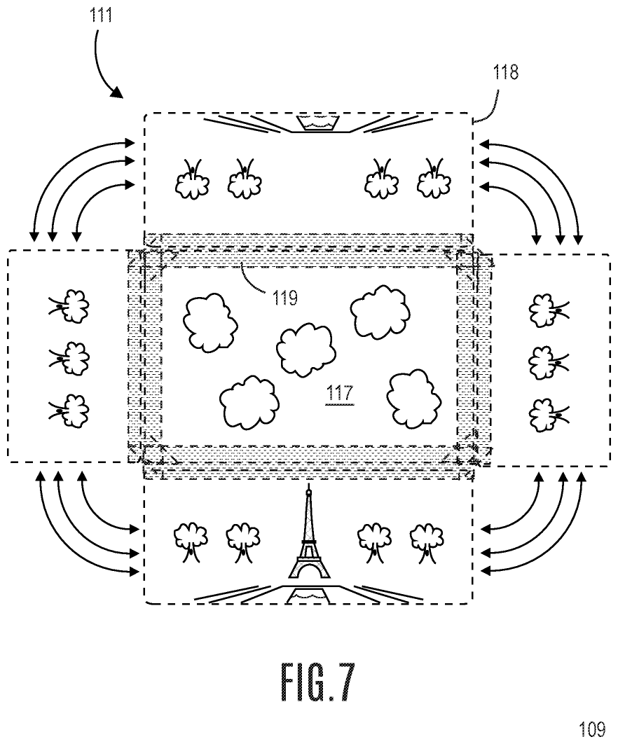

FIG. 7 illustrates a three-dimensional aspect map 111 including a first map-component 117 configured to be associated with a planar ceiling sub-array of a corresponding integrated array of display panels, a second map-component 118 configured to be associated with a planar wall sub-array of a corresponding integrated array of display panels, and a curved map-component 119 for display on a corresponding curved array at an abutment between the ceiling and wall sub-arrays. The illustrated three-dimensional aspect map is configured to fold together in virtual space forming a rectangular three-dimensional surface corresponding a rectangular integrated array of display panels.

### Spherical Video Camera Mount

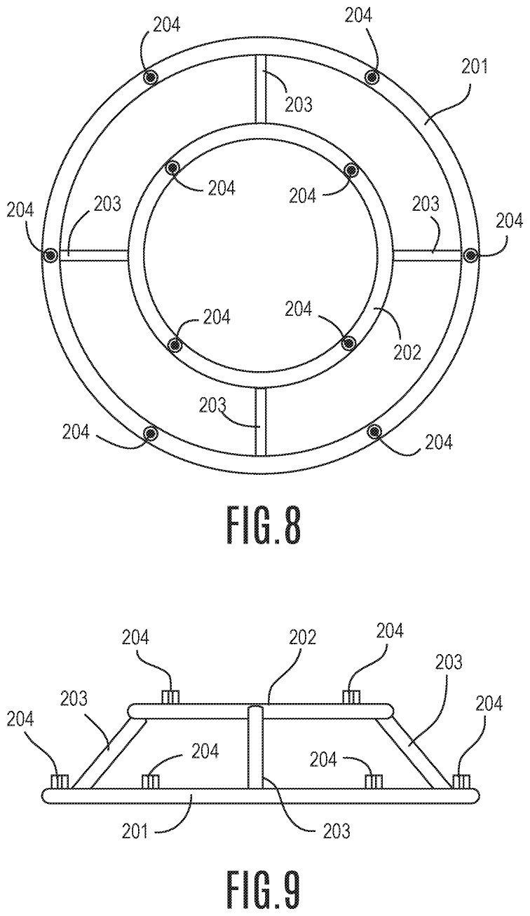

FIG. 8 is a top plan view of a spherical video camera mount 200 for obtaining spherical video content from a plurality of cameras. In this illustrated embodiment, a spherical video camera mount 200 comprises a first annular support 201 coupled to a second annular support 202 via a plurality of linkages 203, specifically four linkages each disposed equidistant about the annular supports. A plurality of camera mounting elements 204 are disposed at a top surface of each of the annular supports, with six camera mounting elements disposed on the first annular support, and four camera mounting elements disposed on the second annular support, each camera mounting element being disposed along the respective annular support in equidistant relation with one another. In this regard, six camera mounting elements are arranged equidistant with respect to one another along a top surface of the first annular support. In addition, four camera mounting elements are arranged equidistant with respect to one another along a top surface of the second annular support. A total of ten cameras will each be attached to one of the camera mounting elements during use. The four cameras corresponding to the second annular support can be configured to capture video of a sky or above-head field of view; whereas the six cameras corresponding to the first annular support can each be configured to point outwardly in a three-hundred-sixty-degree horizontal view. Software, such as video stitching, is used to combine the ten video perspectives into a spherical video content (or hemi-spherical video content if ground view is not captured).

FIG. 9 is a side plan view of the spherical video camera mount 200 of FIG. 8. Each of the first annular support 201, second annular support 202, linkages 203, and camera mounting elements 204 are further illustrated from the side perspective.

Thus, as implied above, the term “spherical video content” and “hemispherical video content” are each interchangeable herein and merely differentiated in that the hemispherical video content omits ground-direction video but includes horizon and above-head fields of view.

Although the system(s) and/or method(s) of this disclosure have been described in detail for the purpose of illustration based on what is currently considered to be the most practical and preferred implementations, it is to be understood that such detail is solely for that purpose and that the disclosure is not limited to the disclosed implementations, but, on the contrary, is intended to cover modifications and equivalent arrangements that are within the spirit and scope of the appended claims. For example, it is to be understood that the present disclosure contemplates that, to the extent possible, one or more features of any implementation can be combined with one or more features of any other implementation.

### REFERENCE SIGNS LIST

room (100)
ceiling (101)
walls (102)
abutment (103)
floor (104)
flat-display panel (105)
curved-display panel (106)
spherical video content (107)
apex (108)
curve-fitting signature (109)
fitted video content (110)
three-dimensional aspect map (111)
first array of flat-display panels (112)
second array of flat-display panels (113)
array of curved-display panels (114)
integrated array of display panels (115)
periphery (116)
first map-component (117)
second map-component (118)
curved map-component (119)
spherical video camera mount (200)
first annular support (201)
second annular support (202)
linkage (203)
camera mounting element (204)

What is claimed is:

1. A system for providing a simulated environment to one or more persons within a room, the system comprising:
an integrated array of display panels extending about a periphery of the room, the integrated array of display panels forming a three-dimensional surface, wherein the three-dimensional surface correlates with a three-dimensional aspect map; and
fitted video content configured for display on the integrated array of display panels, the fitted video content comprising spherical video content being modified with a curve-fitting signature;
wherein the curve-fitting signature is configured to adapt the spherical video content according to the three-dimensional aspect map.

2. The system of claim 1, wherein the integrated array of display panels is configured to extend from floor to ceiling about the periphery of the room.

3. The system of claim 1, wherein the integrated array of display panels is configured to extend about a ceiling along the periphery of the room.

4. The system of claim 1, wherein the integrated array of display panels comprises:
a first array of flat-display panels adapted to cover a first surface of the room,
a second array of flat-display panels adapted to cover a second surface of the room that is distinct from the first surface, and
an array of curved-display panels connected to each of the first and second arrays and forming a transition therebetween.

5. The system of claim 4, wherein the three-dimensional aspect map comprises a first map-component for display on the first array of flat-display panels, a second map-component for display on the second array of fat-display panels, and a curved map-component for display on the array of curved-display panels.

6. A method for providing a simulated environment to one or more persons within a room, the method comprising:
obtaining a three-dimensional aspect map corresponding to an integrated array of display panels;
obtaining spherical video content;
modifying the spherical video content with a curve-fitting signature to convert the spherical video content to fitted video content, wherein the curve-fitting signature is configured to adapt the spherical video content according to the three-dimensional aspect map for fitment with the integrated array of display panels; and
displaying the fitted video content on the integrated array of display panels.
